(19) United States
(12) Patent Application Publication
(10) Pub. No.: US 2004/0169114 A1
(43) Pub. Date: Sep. 2, 2004

(54) Satellite dish antenna mount

(76) Inventor: Barry Dierkes, Long Beach, CA (US)

Correspondence Address: I. Michael Bak-Boychuk, P.O. Box 32501, Long Beach, CA, 90832, US

(21) Appl. No.: 10/751,613

(22) Filed: Jan. 5, 2004

Related U.S. Application Data
(63) Continuation-in-part of application No. 10/306,278, filed on Nov. 27, 2002, now Pat. No. 6,682,029.
(63) Continuation-in-part of application No. 29/189,455, filed on Sep. 5, 2003.

(51) Int. Cl. F16M 11/24

(52) U.S. Cl. 248/165; 248/910

(57) ABSTRACT

In an array of cooperating parts useful to form a portable satellite dish antenna mount base an assortment of attachments is provided to secure the base to a marina storage box, structural elements of a stabilized recreational vehicle and also to ground. At the same time the interface between the base and the mount itself may be tapered along interfering tapers to render the assembly and disassembly convenient. Once assembled an end mounting post on the mount is aligned to a vertical alignment with the assistance of a bubble level in the post end to support the dish antenna thereon. The base may further include a magnetic compass to aid in the antenna alignment.

### REFERENCE TO RELATED APPLICATION

This application is a continuation-in-part of U.S. patent application Ser. No. 10/306,278 filed on Nov. 27, 2002, now U.S. patent______and of U.S. design patent application Ser. No. 29/189,455 filed on Sep. 5, 2003. The benefits of these earlier filing dates are claimed for all matter common therewith.

### BACKGROUND OF THE INVENTION

1. Field of the Invention

The present invention relates to satellite dish antenna mounts, and more particularly to a conveniently transported mount assembly useful to combine into a dish antenna mount that may be generally fixed at various selected orientations.

2. Description of the Prior Art

The transmission of television and other similar signals has gone through several evolutions, first in the form of broadband radio signal then followed by various land lines or cable networks. In each instance either the physical burden of various in-ground or overhead cables or the width of the useable electromagnetic spectrum have limited the number of available programming sources. The granulation of available programming bandwidths, however, has recently gone through a dramatic evolutionary step with the recent advent of transmission techniques relying on geosynchronous satellites each serving as the signal emitting source for a particular program grouping, this evolution then being further reinforced by legislation like the Telecommunications Act of 1996.

In this latter method the satellites associated with each particular signal group are distributed equatorially above the Earth, with a singular line of sight set of coordinates then ascribed to each geographic location. These alignment coordinates are then used for orienting the sensing axes of highly polarized antennae generally known as a satellite dish. The fixed nature of the viewing coordinates has led to a generally universal, more or less permanent, installation process with the fixed satellite dish mounting structure positioned adjacent the residence that is serviced thereby and the installation process then providing the customer garnering mechanism for a particular program source.

In typical practice the coordinates for each antenna location are expressed as a corrected magnetic North azimuth and degrees of elevation from the local horizontal plane. As a consequence installation facility has become generally widespread and along with the wide acceptance of satellite programming by fixed residences there has also now emerged a robust trend to implement movable structures like recreational vehicles or motor homes with deployable antenna mounts. These deployable mounts most often follow the earlier practices of satellite based surveying or measuring antennae typically supported on an adjustable tripod, such as those described in U.S. Pat. No. 4,767,090 issued to Hartman, et al.; U.S. Pat. No. 5,249,766 issued to Vogt; U.S. Pat. No. 5,614,918 issued to Dinardo, et al.; U.S. Pat. No. 5,769,370 issued to Ashjace; U.S. Pat. No. 6,450,464 issued to Thomas; and others. Similar tripod mounted structures are also commercially sold, as for example the tripod mount sold under the model designation TR-2000 Tripod/Base Mount by the Winegard Company, 3000 Kirkwood Street, Burlington, Iowa 52601-2000. While suitable for the purposes intended each of the foregoing entail complex assortments of parts which include metal structures that distort or wholly obliterate any magnetic compass reading, while those made wholly of plastic like the antenna mount sold under the mark or model “The Buoy” by Camping World, Three Springs Road, P.O. Box 90017, Bowling Green, Ky. 42102-9017, lack the leveling indicia for alignment precision. Thus either the resulting measurement and erection complexity or lack of precision have unnecessarily detracted from the use convenience and proliferation of the deployable mount has been less than ringing in the recent past. A conveniently assembled, variously supported mount structure is therefore extensively desired and it is one such structure that is disclosed herein.

### SUMMARY OF THE INVENTION

Accordingly, it is the general purpose and object of the present invention to provide an erectable antenna mount assembly all the parts thereof being formed from non-magnetic materials.

Other objects of the present invention are to provide a conveniently erected antenna mount assembly supported on a base container that is selectively ballasted by storing water therein.

Further objects of the invention are to provide an array of cooperating parts that are conveniently interlocked and thereafter aligned to support an antenna dish.

Yet additional objects of the invention are to provide an interlocking array of parts that is easily assembled to form a satellite dish antenna mount provided with structural interlocks that are engaged without substantial ambiguity.

Further and other objects of the invention are to adapt a portable dish antenna mount assembly for various mounting applications.

Briefly, these and other objects are accomplished within the present invention by providing a generally hollow base formed as an annular liquid container having the central opening therein keyed and dimensioned for conforming orthogonal receipt of a similarly keyed end of a cylindrical mount. The other end of the mount is then provided with a selectively releasable universal swivel fixed by threaded advancement of the bottom end of a support post extending therefrom. The support post, in turn, terminates at the other end in a dished cavity into which a leveling bubble assembly is placed which is then useful to align the support post on the cylindrical mount to a generally vertical alignment regardless of the inclination of the hollow base. Once aligned the base is then filled with water to provide ballast fixing the base on the ground.

Preferably the hollow base, the cylindrical mount and the support post are all formed of a polymeric material structure, such as polyvinyl chloride or other generally rigid polymer structure having material properties that allow the machining and cutting thereof Similarly, the pivoting mechanism fixing the support post alignment relative the cylindrical mount also comprises non-magnetic components, the non-ferrous assembly therefore allowing use of an inexpensive magnetic compass to assist in the orientation of the base along a predetermined azimuth. In this manner the induced magnetic distortion errors that are usually associated with unwanted distortions of the local magnetic field are wholly avoided. This cooperative structural arrangement is further simplified by way of a threaded extension of the mounting post into a domed ball surface captured between a cap on the end of the cylindrical mount by a helical spring and a dished surface within the cylinder opposing the threaded extension or the post so that a partial turn thereof then provides the frictional interlock to fix its generally vertical alignment as determined by the bubble level seated in the free end of the post. A satellite dish antenna, conventionally provided with elevation adjustment, can then be fixed to the mounting post along the azimuth referenced to the compass.

One will appreciate that the planform of the base container and its several surfaces may be variously shaped for clear visual indication of the azimuth alignment thereof Moreover various storage provisions may be formed in the surfaces of the container that retain the compass and the component array of the cylindrical support assembly. In this manner a convenient, easily transported and easily aligned antenna mount assembly is provided that is useful at all geographic locations.

It is to be noted that the utility of the foregoing mount assembly is particularly effective in a mobile setting and an alternative attachment structure is therefore provided conformed for engagement to the ladder parts and hand-hold structures of recreational vehicle. For those traveling by water where boat movement even when at the dock precludes useful reception an arrangement is provided that conveniently attaches the base to the typical triangular lid of a dock box. In these applications the three supports of the hollow base may be provided with extendable laniards that are then tied to the lid or, alternatively, a three legged platform may be provided of a planform similar to the above hollow base, the platform again including a central mounting aperture for receiving the cylindrical mount and also several openings along the edge to be engaged by elastic cords again capturing the lid. In this manner wide utility is obtained in a minimal complement.

### BRIEF DESCRIPTION OF THE DRAWINGS

FIG. 1 is a perspective illustration, separated by parts, of the inventive satellite dish antenna mount assembly;

FIG. 2 is yet another perspective illustration of the inventive antenna mount assembly in its deployed form;

FIG. 3 is a sectional detail view taken along line 3-3 of FIG. 2;

FIG. 4 is a plan view illustration of the inventive antenna mount assembly in its collapsed form for convenient storage;

FIG. 5 is a side view of the collapsed assembly shown in FIG. 4;

FIG. 6 is yet a further perspective illustration of an alternative implementation of the inventive mount assembly conformed for attachment to the top cover of a dock storage box;

FIGS. 7a and 7b are each perspective illustrations, separated by parts, of a mounting adapter sub-assembly useful to support the inventive mount from either a vertical or a horizontal structural member of a recreational vehicle;

FIG. 8 is a sectional view taken along line 8-8 of FIG. 2 illustrating a further alternative configuration for fixing the post assembly in the base of the inventive mount;

FIG. 9 is a perspective illustration, once more separated by parts, of mounting adapter for rendering more convenient the installation of the satellite dish assembly onto the inventive mount; and

FIGS. 10a, 10b and 10c are each perspective details of a further mounting attachment.

### DESCRIPTION OF THE PREFERRED EMBODIMENT

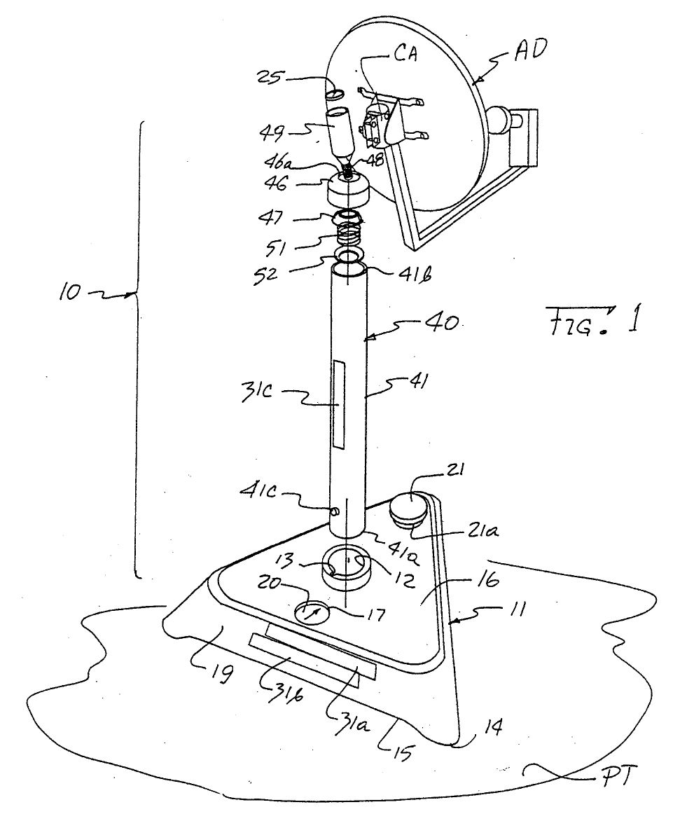

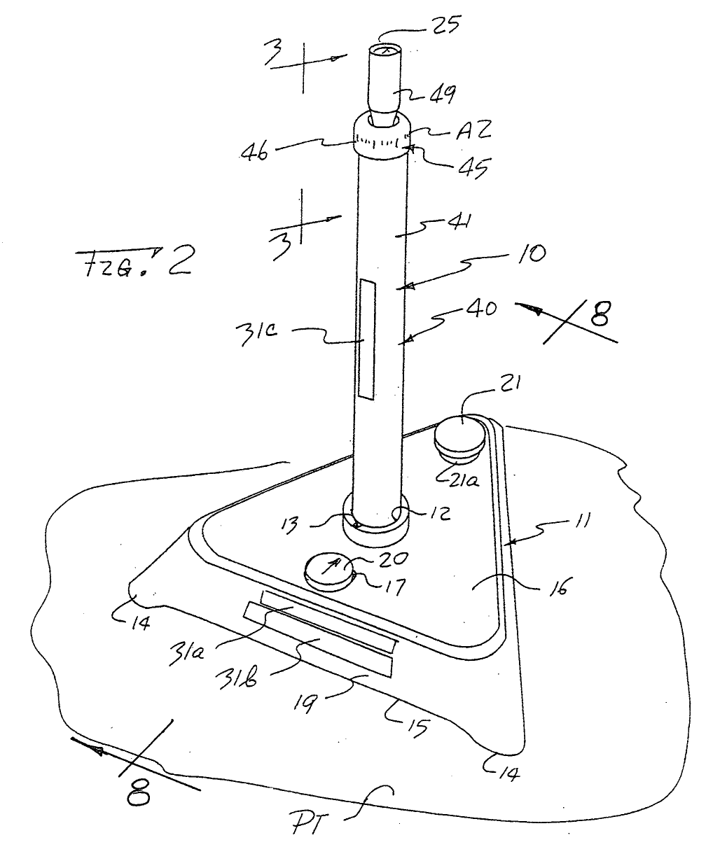

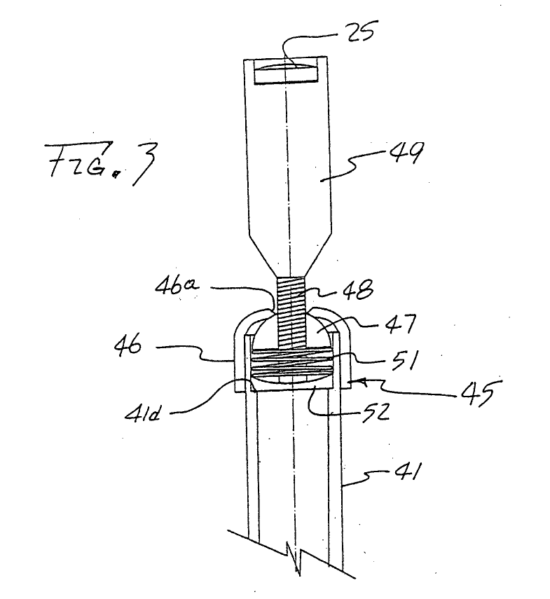

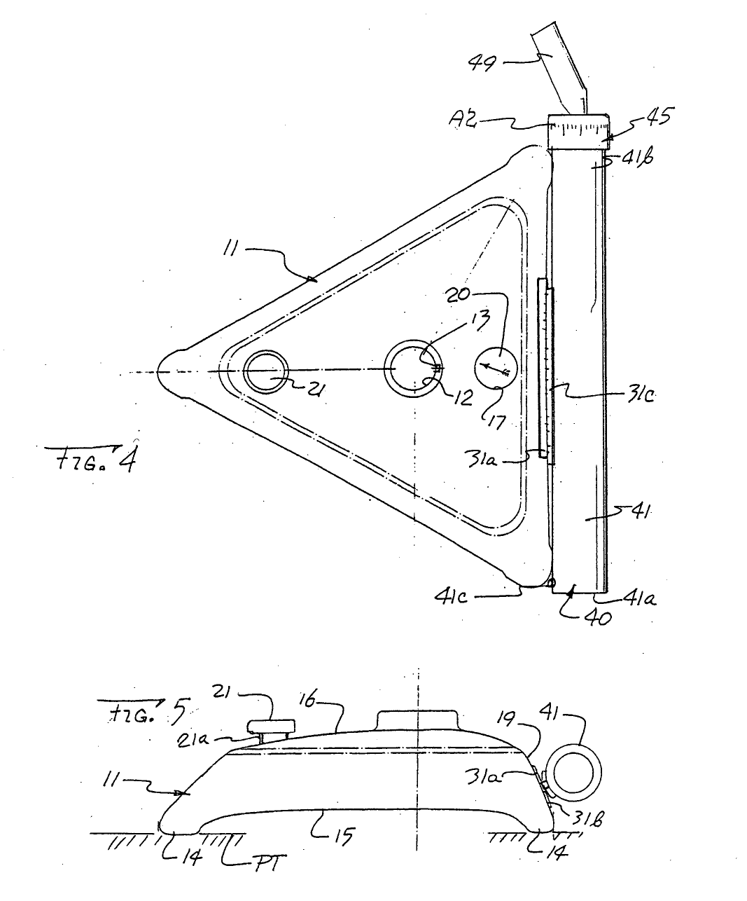

As shown in FIGS. 1 through 5, the inventive antenna mount assembly, generally designated by the numeral 10, includes a hollow base container 11 of a generally triangular planform provided with a vertically aligned circular annulus 12 radially deformed to include a keyway 13, thus forming a triangular enclosure supported on pads 14 along its bottom surface 15 at each apex of the triangle. The upper surface 16 of the container 11, in turn, is provided with a circular depression 17 conformed for fitted receipt of a magnetic compass 20 adjacent one rear panel 19 of the container which further includes in opposed alignment at the distally opposite apex a fill opening 21a closed by a threaded cap 21, thus forming an enclosure into which water can be selectively admitted to weigh down the base and thereafter drained out before transport.

The generally elongate rear surface 19 may also serve as a storage panel for the other components of the assembly 10, including the storage of a cylindrical mount assembly 40 effected by hoop-and-pile strips 31a and 31b adhered on surface 19 engaging a similar strip 31c on the exterior of a cylindrical segment 41 forming the primary support element of mount assembly 40. Upon arrival to the placement site or terrain PT where the satellite dish antenna is to be deployed, the mount assembly 40 is released from this captive engagement and then fixed in the annulus 12 of the base container 11 by inserting the lower end 41a of the cylindrical segment 41 therein. The upper end 41b of segment 41 is then useful to deploy an adjustably securable universal pivot structure generally shown at 45, described in more detail below, above the base with the receiving orientation of segment 41 in annulus 12 fixed by a projecting key 41c inserted in the keyway 13 that is also aligned with a north-south orientation of the compass azimuth and the planform position of the fill opening 21a. Thus a coordinated north-south orientation is provided in the alignment of the magnetic compass 20 and also in the orientation of the apex marked by the fill opening 21a relative the rear surface 19. Once the assembly is thus generally aligned the final adjustment to a vertical orientation is effected by manual movement of an adjustable mounting post 49 that projects from the universal pivot structure 45 with the assistance of a bubble level 25 seated in the free end of the post. The assembly is then in position to support the conventionally vended antenna dish assembly AD that itself includes further provisions for the final elevation and azimuth adjustments.

Those in the art will appreciate that an equatorial geosynchronous satellite transmission system will invariably entail a generally southward antenna focus for all receiving antennae in the northern hemisphere of the Earth while those viewing in the southern hemisphere will necessarily be pointing generally northward. Thus a well indicated north-south orientation greatly assists in selecting the desired terrain on which the assembly is erected, particularly since the range of any adjustment is always limited. To further assist in the final alignment of the dish AD the pivot assembly 45 may also include azimuth markings AZ about its periphery geometrically referenced through the keyed insertion of the cylindrical segment. Thus all the necessary indicia are imbedded in the inventive assembly which is then fixed by water ballast in the base.

In more detail, pivot structure 45 is defined by an end cap 46 mounted onto the upper end 41b of segment 41 to capture therebetween a generally hemispherical, centrally threaded pivot base 47 engaged by a threaded projection 48 extending axially from the mounting post 49 into the interior of cap 46 through a chamfered opening 46a. The interior surface of the segment's upper end is further provided with an internal seat or shoulder 41d supporting the peripheral edge a circular dished plate 52 aligned to oppose and thus limit the threaded advancement of projection 48 through the pivot base 47. A helical spring 51 compressed between plate 52 and the pivot base 47 then maintains frictional contact between the pivot base and the interior surface of cap 46, right at the chamfered edge of the opening 46a, and the dished arc of plate 52, selected to match the pivot arc of projection 48, is then useful to lock the post alignment with a small, fractional further turn advancing projection 48 against plate 52, thus providing a convenient locking mechanism fixing the post relative the cylinder 41. This conveniently locked and unlocked final alignment of the post 49 is made with concurrent visual reference to the bubble level 25 received in the free end of the post. Once thus aligned to a vertical alignment and locked, the mounting post is then captured by the clamping attachment CA normally provided with the antenna dish AD, fixing the antenna along the specified azimuth and elevation. This azimuth selection may be further assisted by scribing the exterior of cap 46 with the compass markings AZ that are coordinated with the compass alignment in the base.

It will be appreciated that the foregoing structure may be conveniently formed thereof can be effected by well known adhesive processes. Moreover, by selecting conventional pipe dimensions commercially vended water conveying or electrical pipe can be utilized along with all the conventional fittings and caps that are concurrently vended therewith. The hook-and-pile strips are similarly of conventional form, often referred to by their mark or style “Velcro” and variously distributed as strips provided with adhesive backing. Thus widely available, conveniently formed and assembled components are combined to form an antenna mount that is easily and accurately deployed.

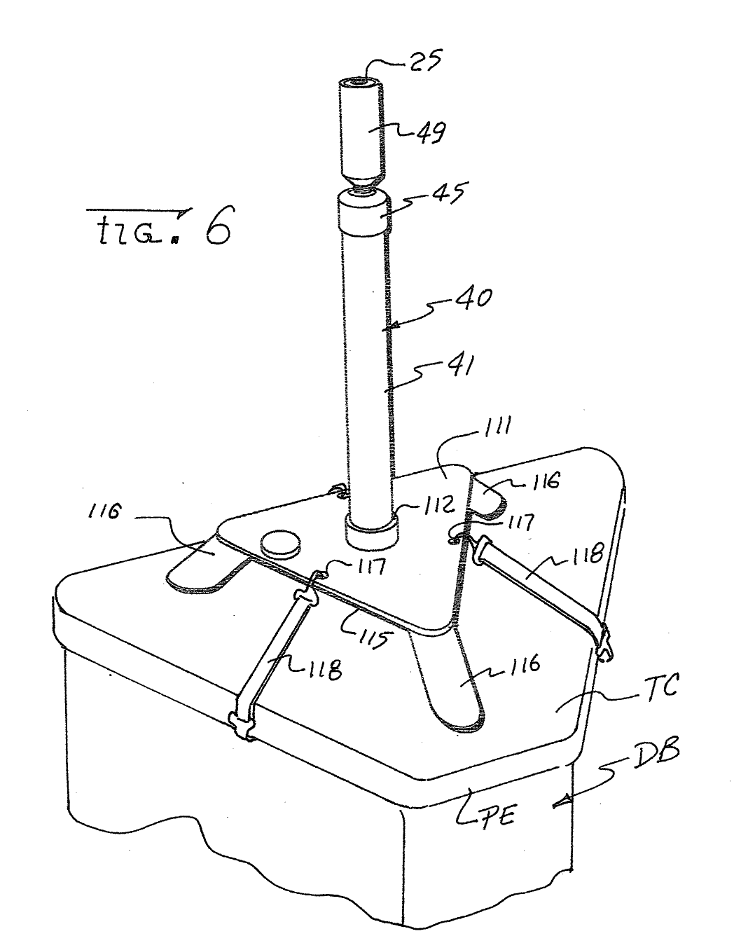

By reference to FIGS. 6 through 10c several adaptations and modifications can be included in the inventive mount assembly disclosed herein to further expand the usefulness and convenience thereof. For example, the inventive mount assembly can be conveniently adapted for marine use in accordance with the teaching hereinafter set out by particular reference to FIG. 6. Like numbered parts functioning in like manner to that previously described the mount assembly 40 is modified at the lower end of the cylindrical segment 41 to engage an annulus 112 in a triangular platform 111 which on its opposing lower surface 115 is provided with support legs 116 cushioned at their ends by pads 116a when in position on the top cover TC of a dock box DB normally found in a marina. A set of perforations 117 along the edges of the platform 111 are then useful to secure the ends of a plurality of elastic straps 118 which at their other ends then engage the periphery PE of the top cover TC.

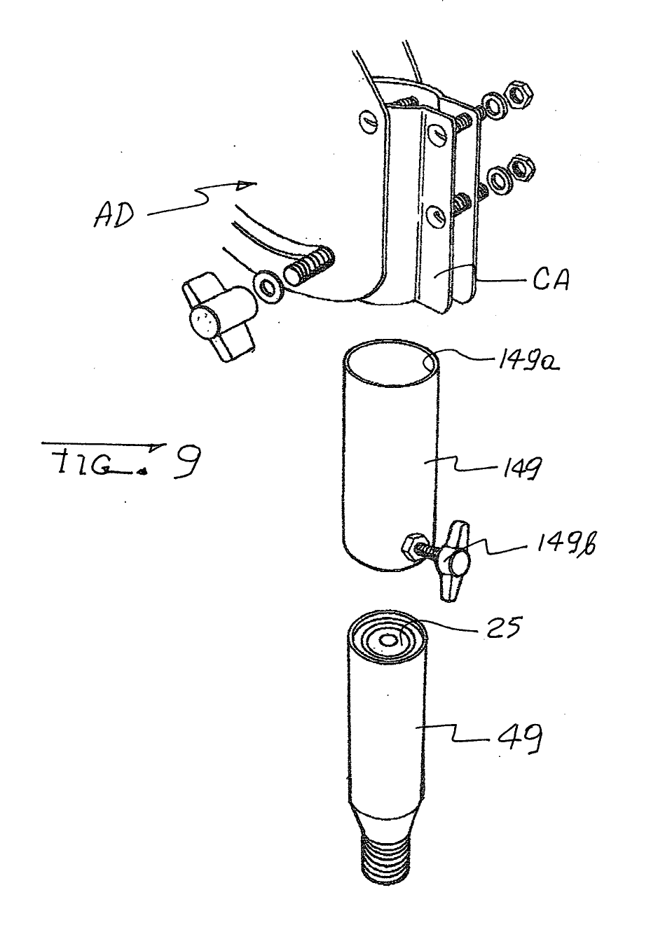

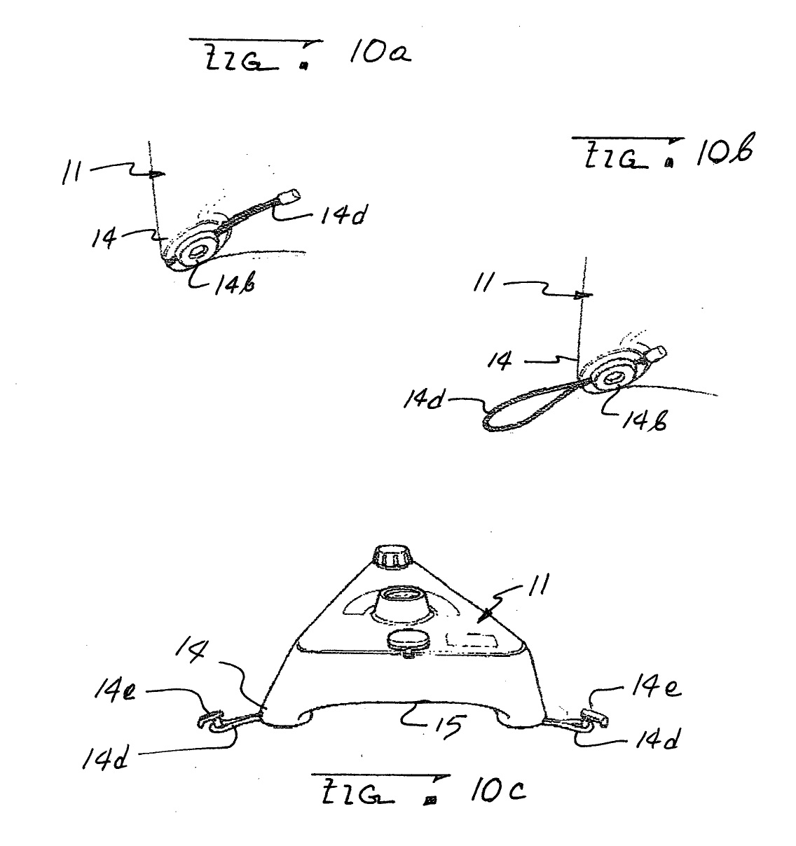

Of course, while this secured attachment obviates the need for a ballasted base structure it is contemplated within the teachings herein that the hollow base container 11 may be similarly provisioned with attachments illustrated in FIGS. 10a through 10c that may also be useful to secure same to the top of the dock box.

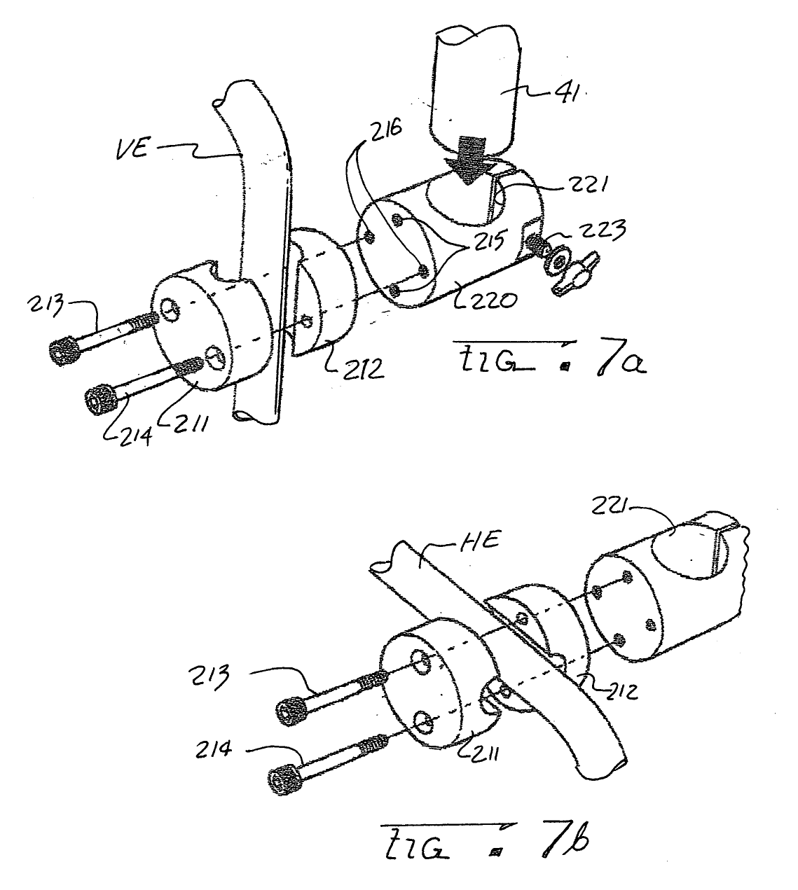

The portability of the instant mount assembly may be also rendered useful with motor homes or recreational vehicles that are stabilized at the temporary site by deployable hydraulic or mechanical supports. Once so stabilized the recreational vehicle RV provides the necessary base from which the mount assembly can then be deployed. To render convenient the attachment of the mount assembly to various structural members of the stabilized vehicle RV a mounting adapter 210 is shown in FIGS. 7a and 7b comprising two mating clam shell halves 211 and 212 defining a common recess which is then clamped onto a horizontal or vertical structural element HE or VE. A set of clamping screws 213 and 214 then extend through the mated shell halves to threadably engage one of two threaded opening sets 215 or 216 in the end of a fitting 220 provided with a split bore 221 conformed to receive the end of the cylindrical segment 41 where it is clamped by a clamping screw 223. In this manner the satellite dish can be deployed directly from a structure like a ladder or luggage rack on the vehicle RV.

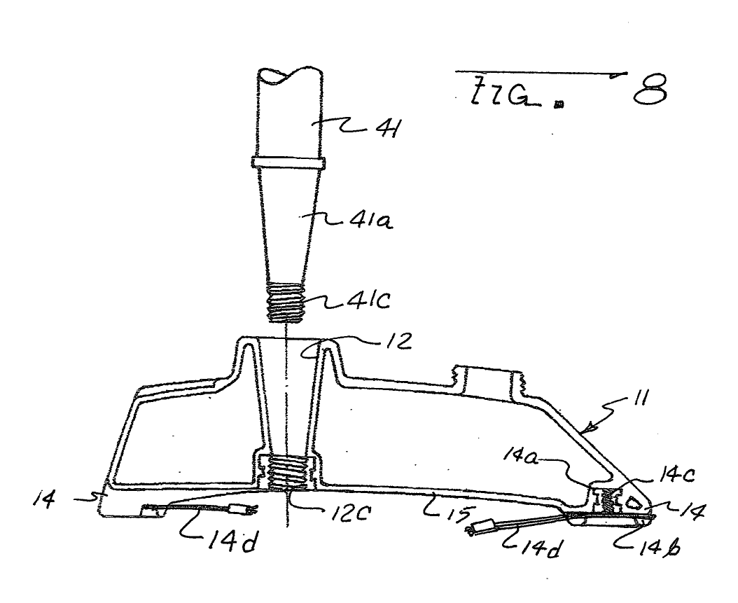

In all the foregoing implementations alternative engagement modes may be utilized to secure the end of the post assembly 40 in the corresponding base. For example, as illustrated in FIG. 8 a mismatched taper may be provided to the lower end portion 41a (or 141a) of the cylindrical segment 41 and the annulus 12 (or 112) threadably drawn to an interference fit by advancing a threaded apex 41c into a similarly threaded end opening 12c in the annulus. This manner of engagement may assist in the assembly convenience of an interlocked structure while also reducing the necessary precision in the mating parts.

Similar simplifications can be effected in the mounting structure of the dish assembly AD as illustrated in FIG. 9. In this modification a tubular sleeve 149 is provided including an interior bore 149a conformed to the exterior dimensions of the post 49. The sleeve is then clamped in the dish mounting assembly CA and a single cinch screw 149b is then useful to secure the dish assembly AD to the mount.

Further securing conveniences can be obtained in the structure of the hollow base container 11 as illustrated in FIGS. 8, 10a, 10b and 10c. More precisely each of the base legs 14 may be provided with a threaded insert 14a which then engages a resilient pad assembly 14b provided with a threaded post 14c. A cable loop 14d is then selectively captured between the pad and the corresponding leg in a deployment subjacent the lower surface 15 or projecting beyond the base planform. When projecting to the exterior each of the loops may be engaged by the aforementioned elastic straps 118 for mounting on a dock locker or may be pinned to the ground by spikes 14e.

It will be appreciated that each of the foregoing variations and adaptations expand the utility of the inventive mount assembly as well as the convenience in its use. In this manner the task of erecting the satellite antenna in the course of travel is greatly simplified thus rendering the assembly convenient and useful. Of course this convenience is not just useful for television signal reception but also in the course of setting up portable satellite communication stations.

Obviously, many modifications and variations can be effected without departing from the spirit of the invention instantly disclosed. It is therefore intended that the scope of the invention be determined solely by the claims appended hereto.

It is claimed:

1. In an assembly cooperating upon the erection thereof to provide an adjustable mount for supporting a satellite dish antenna defined by a generally hollow base container including an upper and lower surface joined at the common peripheries thereof and including a keyed central annulus therebetween, a cylindrical segment conformed for receipt of one end thereof in said annulus and including a mounting post at the other end engaged by a manually operable pivot for selecting the alignment of said post relative said segment, said pivot including a perforated cap secured to said other end of said segment, a generally hemispherical threaded fitting retained within the common interior of said cap and segment, a helical spring for urging said fitting against said cap, a threaded projection extending from said post through the perforation in said cap and threadably passing through said fitting and opposing means fixed in said segment for opposing said spring and further threaded advancement of said projection; and level indicating means secured to said mounting post, the improvement comprising:
said lower surface of said base including a plurality of legs for the support thereof, each said leg being provided with a corresponding flexible loop conformed for sliding deployment from a stored position subjacent said lower surface of said container to an extended position exterior of the common periphery thereof.

2. Apparatus according to claim 1, wherein:
said one end of said segment and the interior of said annulus are each tapered at various angles of taper.

3. Apparatus according to claim 2, wherein:
said upper and lower surface of said hollow base container are each of a generally triangular planform separated from each other to define a cavity therebetween and joined at the common peripheries thereof.

4. In a deployable assembly of cooperating parts conformed to provide upon the erection thereof an adjustable mount for supporting a satellite dish antenna on top of a generally triangular marine dock storage container, and including a cylindrical segment provided with a mounting post at one end conformed to be attached to said satellite dish and engaged by a manually operable pivot for selecting the alignment of said post relative said segment and level indicating means secured to said mounting post, the improvement comprising:
a base including a generally triangular base plate provided with an annulus conformed for receiving the other end of said segment, a plurality of legs for supporting said base plate on said storage container, a plurality of securing perforations formed along the peripheral edge of said base plate and a corresponding plurality of elastic attachment straps for securing said base plate to said dock storage container.

5. Apparatus according to claim 4, wherein:
the other end of said segment and the interior of said annulus are each tapered at various angles of taper.

6. Apparatus according to claim 5, wherein:
each said leg is deployed subjacent a corresponding apex of said base plate and each said securing perforation is formed along the periphery of said base plate intermediate said legs.

7. In a deployable assembly of cooperating parts conformed to provide upon the erection thereof an adjustable mount for mounting a satellite dish antenna onto a selected structural member of a recreational vehicle, and including a cylindrical segment provided with a mounting post at one end conformed to be attached to said satellite dish and engaged by a manually operable pivot for selecting the alignment of said post relative said segment and level indicating means secured to said mounting post, the improvement comprising:
a clamping adapter conformed for clamped engagement to said selected structural member including a pair of opposed clamping pieces defining a common cavity therebetween for securing to one portion of said selected structural member;
a first and second threaded fastener extending through said opposed clamping pieces; and
a securing piece provided with a plurality of threaded opening pairs each spaced for threaded engagement by said first and second fasteners, said securing piece further including a transverse opening dimensioned for receipt of the other end of said cylindrical segment.

8. Apparatus according to claim 7, wherein:
said transverse opening is split along one radius thereof, said split including adjustable bridging means thereacross.

9. Apparatus according to claim 7, wherein:
the other end of said segment and the interior of said transverse opening are each tapered at various angles of taper.
